(19) United States
(12) Patent Application Publication
(10) Pub. No.: US 2015/0052454 A1
(43) Pub. Date: Feb. 19, 2015

(54) FILE SHARING METHOD AND HANDHELD APPARATUS

(71) Applicant: HUIZHOU TCL MOBILE COMMUNICATIION CO., LTD, Huizhou, Guangdong (CN)

(72) Inventor: Wendi Cai, Huizhou (CN)

(73) Assignee: HUIZHOU TCL MOBILE COMMUNICATION CO., LTD, Huizhou, Guangdong (CN)

(21) Appl. No.: 14/387,177

(22) PCT Filed: Jul. 11, 2013
(86) PCT No.: PCT/CN2013/079213

§ 371 Date: Sep. 22, 2014

(30) Foreign Application Priority Data
Dec. 6, 2012 (CN) 201210525915.5

(51) Int. Cl. G06F 3/0486; H04W 76/02; G06F 3/0482; H04W 8/00; H04L 12/18; G06F 3/0481

(52) U.S. Cl. CPC G06F 3/0486; H04L 12/1813; G06F 3/04817; G06F 3/0482; H04W 8/005; H04W 76/02
USPC 715/753

(57) ABSTRACT

The present invention provides a method for sharing file and a handheld device. The method includes collecting devices information about the available digital living network alliance (DLNA) devices which are in a connected mode in the DLNA network by a DLNA module after the handheld device enters a DLNA network, and forming a shortcut list of DLNA devices; dragging a shared file to an icon of a target DLNA device in the shortcut list, wherein the list comprises at least one DLNA device icon; matching the type of a target DLNA device with the type of the shared file by the DLNA module. If the match is successful, the handheld device enables the target DLNA device to process the shared file. The present invention can quickly achieve files for sharing, and it is easy to operate and high in accuracy.

### FIELD OF THE INVENTION

The present disclosure relates to the technical field of digital living network technologies, and more particularly to a file sharing method and a handheld apparatus.

### BACKGROUND OF THE INVENTION

DLNA (Digital Living Network Alliance) is a kind of network information technology that allows for interconnection and intercommunication among a variety of mobile apparatuses via a wireless network so as to achieve the purpose of unlimited sharing of files. The DLNA allows various mobile apparatuses such as mobile phones, computers and television (TV) sets to intelligently communicate shared files with each other via a wireless network. In this way, screens of the various mobile apparatuses can be shared in real time for purpose of entertainment and cooperation among a plurality of users.

In the conventional arts, when employing the DLNA technology to share a file, it is requires the user to enter operation directories with multiple levels sequentially, and then search for DLNA apparatuses that are in a connected status via the wireless network, in order to connect the handheld apparatus with a target DLNA apparatus. Moreover, even after connecting, multiple operations on the DLNA apparatus must be done to acquire a filename of the shared file before sharing the information. Obviously, the conventional art employing the DLNA technology to share the file, needs complex operation steps, and tends to cause error in operation.

Accordingly, a need exists in the art to provide a file sharing method and a handheld apparatus that can solve the aforesaid problems.

### SUMMARY OF THE INVENTION

A main technical problem to be solved in the present disclosure is to provide a file sharing method and a handheld apparatus, which can achieve quick sharing of files, and simple operations and high accuracy.

To solve the aforesaid technical problem, a technical solution adopted in the present disclosure is to provide a file sharing method, which comprises: after a handheld apparatus entering a DLNA network, adding the handheld apparatus into a DLNA sharing apparatus group in a wireless network by a lower-layer service component of a DLNA module, and acquiring information of available DLNA apparatuses that are in a connected status in the DLNA network to form a DLNA apparatus shortcut list; entering a file library of the handheld apparatus, dragging a shared file towards a status bar of the handheld apparatus, calling the DLNA apparatus shortcut list from the lower-layer service component by an upper-layer application, displaying the DLNA apparatus shortcut list in the form of a DLNA apparatus list shortcut menu bar, and then dragging the shared file onto an icon of a target DLNA apparatus in the DLNA apparatus shortcut list that is displayed in the form of the ULNA apparatus list shortcut menu bar, wherein the DLNA apparatus shortcut list comprises at least one icon of at least one DLNA apparatus; matching a type of the target DLNA apparatus with a type of the shared file by the DLNA module; and enabling the target DLNA apparatus to process the shared file by the handheld apparatus if matching successfully.

The step of the handheld apparatus entering the DLNA network comprises: activating a WIFI function by the handheld apparatus to search for and enter the wireless network; and activating the upper-layer application by the DLNA module to enter the DLNA network.

The step of enabling the target ULNA apparatus to process the shared file by the handheld apparatus comprises: receiving an instruction of pulling down a status bar by the handheld apparatus, and displaying a handheld apparatus shortcut menu bar according to the instruction; calling the DLNA apparatus shortcut list from the lower-layer service component by the upper-layer application via clicking an icon of the upper-layer application in the handheld apparatus shortcut menu bar, and displaying the DLNA apparatus shortcut list in the form of the DLNA apparatus list shortcut menu bar; entering an operation interface of the target DLNA apparatus by clicking the icon of the target DLNA apparatus in the DLNA apparatus shortcut menu bar; and processing the shared file via the operation interface of the target DLNA apparatus displayed by the handheld apparatus.

The step of enabling the target DLNA apparatus to process the shared file by the handheld apparatus comprises: calling the upper-layer application by the handheld apparatus and entering a main interface of the upper-layer application, wherein the DLNA apparatus shortcut list is displayed in the main interface; entering an operation interface of the target DLNA apparatus by clicking the icon of the target DLNA apparatus in the DLNA apparatus shortcut list; and processing the shared file via the operation interface of the target DLNA apparatus displayed by the handheld apparatus.

To solve the aforesaid technical problem, another technical solution adopted in the present disclosure is to provide a file sharing method, which comprises: after a handheld apparatus entering a DLNA network, acquiring information of available DLNA apparatuses that are in a connected status in the DLNA network by a DLNA module, to form a DLNA apparatus shortcut list; dragging a shared file onto an icon of a target DLNA apparatus in the DLNA apparatus shortcut list, wherein the DLNA apparatus shortcut list comprises at least one icon of at least one DLNA apparatus; matching a type of the target DLNA apparatus with a type of the shared file by the DLNA module; and enabling the target DLNA apparatus to process the shared file by the handheld apparatus if matching successfully.

The step of the handheld apparatus entering the DLNA network comprises: activating a WIFI function by the handheld apparatus to search for and enter a wireless network; and activating an upper-layer application by the DLNA module to enter the DLNA network.

The step of acquiring information of available DLNA apparatuses that are in a connected status in the DLNA network by the DLNA module to form the DLNA apparatus shortcut list comprises: adding the handheld apparatus into a DLNA sharing apparatus group in a wireless network by a lower-layer service component of the DLNA module, and acquiring the information of the available DLNA apparatuses that are in a connected status in the DLNA network to form the ULNA apparatus shortcut list.

The step of dragging the shared file onto the icon of the target DLNA apparatus in the DLNA apparatus shortcut list comprises: entering a file library of the handheld apparatus, and dragging the shared file towards a status bar of the handheld apparatus; calling the DLNA apparatus shortcut list from a lower-layer service component by an upper-layer application and displaying the DLNA apparatus shortcut list in the form of a DLNA apparatus list shortcut menu bar; and dragging the shared file onto the icon of the target DLNA apparatus in the DLNA apparatus shortcut menu bar.

The step of enabling the target DLNA apparatus to process the shared file by the handheld apparatus comprises: receiving an instruction of pulling down a status bar by the handheld apparatus, and displaying a handheld apparatus shortcut menu bar according to the instruction; calling the DLNA apparatus shortcut list from a lower-layer service component by an upper-layer application via clicking an icon of the upper-layer application in the handheld apparatus shortcut menu bar, and displaying the DLNA apparatus shortcut list in the form of a DLNA apparatus list shortcut menu bar; entering an operation interface of the target DLNA apparatus by clicking the icon of the target DLNA apparatus in the DLNA apparatus shortcut menu bar; and processing the shared file via the operation interface of the target DLNA apparatus displayed by the handheld apparatus.

The step of enabling the target DLNA apparatus to process the shared file by the handheld apparatus comprises: calling an upper-layer application by the handheld apparatus and entering a main interface of the upper-layer application, wherein the DLNA apparatus shortcut list is displayed in the main interface; entering an operation interface of the target DLNA apparatus by clicking the icon of the target DLNA apparatus in the DLNA apparatus shortcut list; and processing the shared file via the operation interface of the target DLNA apparatus displayed by the handheld apparatus.

To solve the aforesaid technical problem, a further technical solution adopted in the present disclosure is to provide a handheld apparatus for sharing a file, which shares the file via a wireless network. The handheld apparatus comprises: a DLNA module, being configured to acquire information of available DLNA apparatuses that are in a connected status in the DLNA network to form a DLNA apparatus shortcut list after the handheld apparatus enters a DLNA network; a display module, being configured to display the DLNA apparatus shortcut list and receive an instruction of dragging the shared file onto an icon of a target DLNA apparatus in the DLNA apparatus shortcut list, and display a corresponding animation according to the instruction, wherein the DLNA apparatus shortcut list comprises at least one icon of at least one DLNA apparatus icon; the DLNA module is further configured to match a type of the target DLNA apparatus with a type of the shared file; and a shortcut operation module, being configured to enable the target DLNA apparatus to process the shared file after matching successfully.

The handheld apparatus further comprises a WIFI module, which is configured to activate a WIFI function to search for and enter a wireless network; and the DLNA module activates an upper-layer application to enter the DLNA network.

The DLNA module further comprises a lower-layer service component. The lower-layer service component is configured to add the handheld apparatus into a DLNA sharing apparatus group in the wireless network, and acquire the DLNA apparatus shortcut list from the wireless network, and the upper-layer application is configured to call the DLNA apparatus shortcut list from the lower-layer service component.

The handheld apparatus further comprises a shortcut menu bar module, which is configured to form a DLNA apparatus list shortcut menu bar according to the DLNA apparatus shortcut list called by the upper-layer application of the DLNA module.

The present disclosure has the following benefits: different from the prior art, the present disclosure can search for DLNA apparatuses that are in a connected status in the DLNA network via the handheld apparatus, display the corresponding DLNA apparatus information in the DLNA apparatus shortcut list, and then drag a file to be shared onto an icon of a corresponding DLNA apparatus in the DLNA apparatus shortcut list, thus achieving the playing or sending of the shared file. The present disclosure can achieve quick sharing of files, and simple operations and high accuracy.

### BRIEF DESCRIPTION THE DRAWINGS

FIG. 1 is a flowchart diagram illustrating a file sharing method according to an embodiment of the present disclosure;

FIG. 2 is a schematic view illustrating the animation of dragging a shared file to a DLNA apparatus shortcut list according to the present disclosure;

FIG. 3 is a diagram illustrating the correspondence relationship between a target DLNA apparatus and shared files according to the present disclosure;

FIG. 4 is a first schematic view illustrating the process of operating a target DLNA apparatus to process a shared file of the present disclosure;

FIG. 5 is a second schematic view illustrating the process of operating a target DLNA apparatus to process a shared file of the present disclosure; and

FIG. 6 is a schematic structural view of a handheld apparatus according to an embodiment of the present disclosure.

### DETAILED DESCRIPTION OF THE INVENTION

The present disclosure will be detailed hereinbelow with reference to the attached drawings and the embodiments.

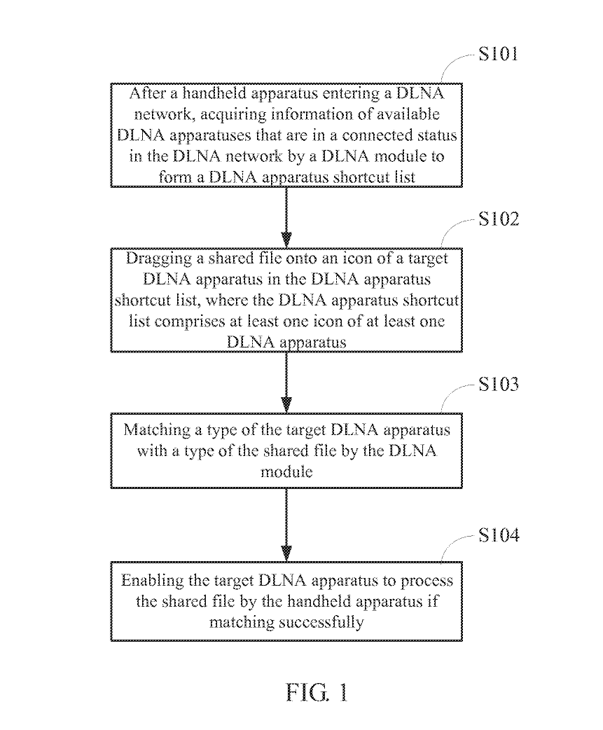

FIG. 1 is a flowchart diagram illustrating a file sharing method according to an embodiment of the present disclosure. As shown in FIG. 1, the file sharing method of this embodiment comprises following steps of:

Step S101: after a handheld apparatus entering a DLNA network, acquiring information of available DLNA apparatuses that are in a connected status in the DLNA network by a DLNA module to form a DLNA apparatus shortcut list.

In this embodiment, the handheld apparatus is preferably an intelligent touch screen mobile phone. A user activates a WIFI function of the handheld apparatus to search for and enter a wireless network via the intelligent touch screen of the handheld apparatus. After that, the user activates an upper-layer application via a DLNA module to enter the DLNA network.

After the handheld apparatus enters the DLNA network, a lower-layer service component of the DLNA module automatically adds the handheld apparatus into a DLNA sharing apparatus group in the wireless network, and acquires information of available DLNA apparatuses that are in a connected status in the DLNA network to form a DLNA apparatus shortcut list.

In this embodiment, the DLNA apparatus is any of a variety of media playing and processing apparatuses such as mobile phones, computers, TV sets and sound boxes.

Step S102: dragging a shared file onto an icon of a target DLNA apparatus in the DLNA apparatus shortcut list.

The DLNA apparatus shortcut list comprises at least one icon of at least one DLNA apparatus that corresponds to the DLNA apparatus, and the icon of the DLNA apparatus is formed according to the DLNA apparatus information corresponding to available DLNA apparatuses that are in a connected status in the DLNA network.

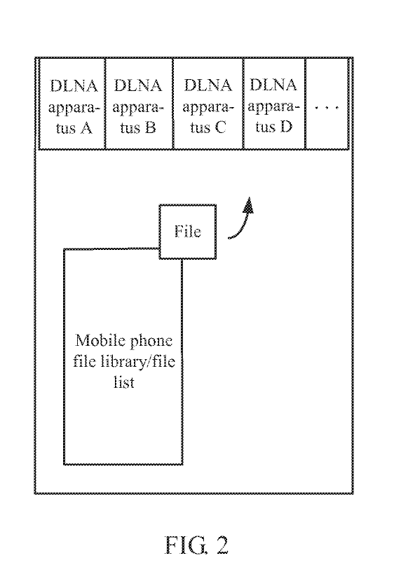

After entering a file library or a media library of the handheld apparatus, the user clicks a shared file and then drags the shared file towards a status bar on a screen of the handheld apparatus (as shown in FIG. 2). Then, the DLNA module of the handheld apparatus automatically activates an upper-layer application, calls the DLNA apparatus shortcut list from a lower-layer service component and displays the DLNA apparatus shortcut list on the screen in the form of a DLNA apparatus list shortcut menu bar. The user drags the shared file onto an icon of a target DLNA apparatus in the DLNA apparatus shortcut menu bar and then releases it so that the target DLNA apparatus that is going to process the shared file is selected.

Step S103: matching a type of the target DLNA apparatus with a type of the shared file by the DLNA module.

After the user drags the shared file onto the icon of the target DLNA apparatus in the DLNA apparatus shortcut menu bar, the shared file will not be immediately processed by the target DLNA apparatus. Generally speaking, before dragging the file, the user purposefully selects the icon of the target DLNA apparatus that is capable of processing the shared file according to the type of the shared file. However, in the actual operation, the user might accidentally drag the shared file onto the icon of the target DLNA apparatus that is incapable of processing the shared file because of various maloperations, which can prevent the user from experiencing the convenience brought by the file sharing. For example, when the user drags a video file onto an icon corresponding to the sound box, the video file can not be played by the sound box.

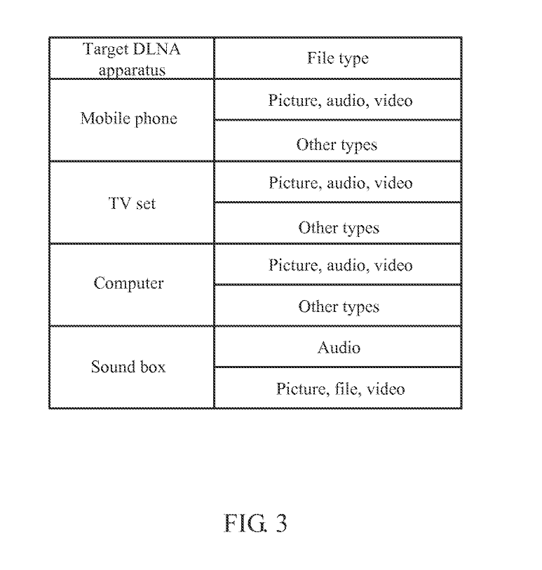

Therefore, it is necessary to provide a DLNA module to match the type of the target DLNA apparatus with the type of the shared file in this embodiment. Correspondingly, in the present embodiment, the correspondence relationship between the type of the target DLNA apparatus and the type of the shared file may be preset in the handheld apparatus, as shown in FIG. 3. It should be appreciated that, the correspondence relationship of this embodiment is not limited to what is shown in FIG. 3.

Step S104: enabling the target ULNA apparatus to process the shared file by the handheld apparatus if matching successfully.

In this embodiment, if the DLNA module matches the type of the target DLNA apparatus with the type of the shared file successfully according to the correspondence relationship shown in FIG. 3, that is, if it is determined that the target DLNA apparatus is capable of processing the shared file that is dragged, then the target DLNA apparatus processes the shared file according to the type of the shared file. The processing includes playing the shared file and sending the shared file.

If matching of the type of the DLNA apparatus with the type of the shared file the by DLNA module fails, that is, if it is determined that the target DLNA apparatus is incapable of processing the shared file that is dragged, then a prompt window can be displayed on the screen of the handheld apparatus to remind the user to reselect a target DLNA apparatus that is capable of processing the shared file.

It should be appreciated that, in this embodiment, the user may operate the target DLNA apparatus to process the shared file that is dragged in two ways.

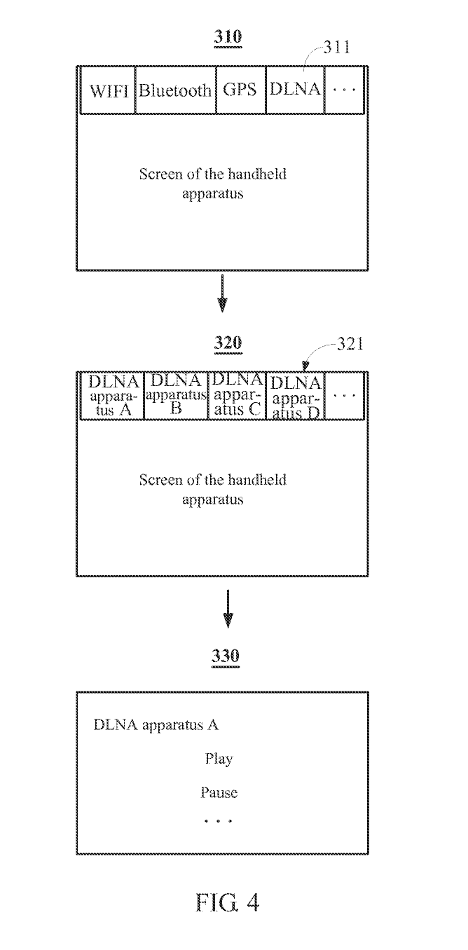

FIG. 4 is a first schematic view illustrating the process of operating a target DLNA apparatus to process a shared file according to the present disclosure. As shown in FIG. 4, the user pulls down the status bar on the touch screen of the handheld apparatus. Then, the handheld apparatus receives the instruction of pulling down the status bar, and displays a handheld apparatus shortcut menu bar according to the instruction, and thus enters a handheld apparatus shortcut menu bar interface 310 having an icon 311 of a DLNA upper-layer application. The handheld apparatus shortcut menu bar interface 310 is similar to a shortcut menu bar interface for operating the WIFI, the Bluetooth, or the GPS in an Android apparatus. After that, when the user clicks the icon 311 of the DLNA upper-layer application, the upper-layer application calls the DLNA apparatus shortcut list from the lower-layer service component, and displays the DLNA apparatus shortcut list in the form of a DLNA apparatus list shortcut menu bar (i.e., a DLNA apparatus list shortcut menu bar 321 in an interface 320).

Then, the user enters an operation interface 330 of the target ULNA apparatus by clicking the icon of the target DLNA apparatus in the DLNA apparatus shortcut menu bar. Then, the user can process the shared file that is dragged via the operation interface 330 of the target DLNA apparatus that is displayed on the screen of the handheld apparatus, for example, play, pause, share, send and delete the file.

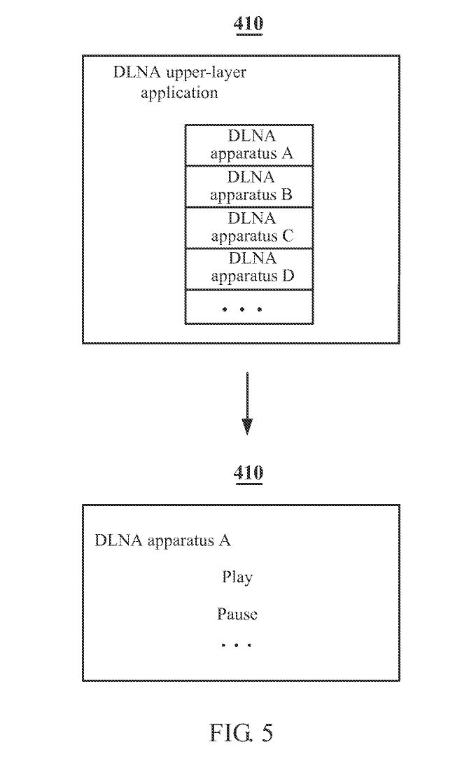

FIG. 5 is a second schematic view illustrating the process of operating a target DLNA apparatus to process a shared file according to the present disclosure. As shown in FIG. 5, the user calls an upper-layer application of a handheld apparatus via the handheld apparatus, and enters a main interface 410 of the upper-layer application; and a DLNA apparatus shortcut list is shown in the main interface 410.

Thereafter, the user enters an operation interface 420 of a target DLNA apparatus by clicking an icon of a target DLNA apparatus in the DLNA apparatus shortcut list. Then, the user can process a shared file that is dragged via the operation interface 420 of the target DLNA apparatus that is displayed on the screen of the handheld apparatus.

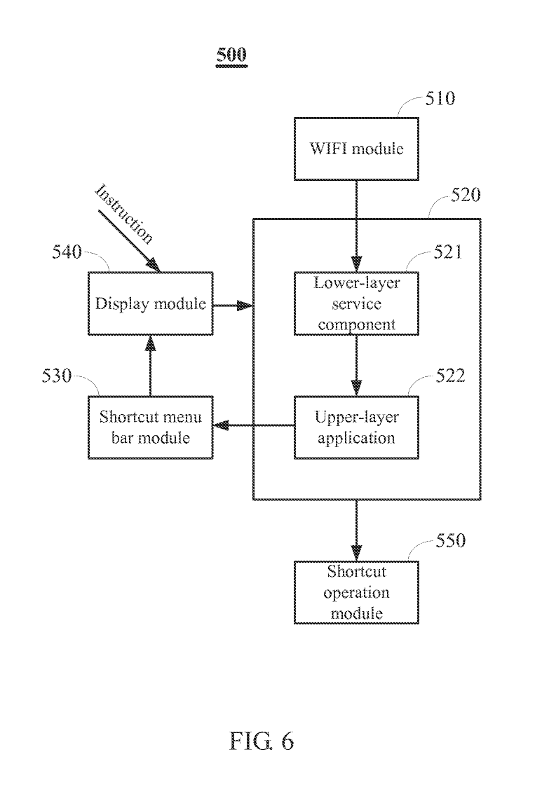

FIG. 6 is a schematic structural view illustrating a handheld apparatus for file sharing according to an embodiment of the present disclosure. As shown in FIG. 6, a handheld apparatus 500 of this embodiment shares a file via the wireless network. The handheld apparatus 500 comprises a WIFI module 510, a DLNA module 520, a shortcut menu bar module 530, a display module 540 and a shortcut operation module 550. The DLNA module 520 consists of a lower-layer service component 521 and an upper-layer application 522.

In this embodiment, the WIFI module 510 is configured to activate a WIFI function to search for and enter a wireless network.

The lower-layer service component 521 is configured to add the handheld apparatus 500 into a DLNA sharing apparatus group in the wireless network, and acquire the DLNA apparatus shortcut list from the wireless network.

The upper-layer application 522 is configured to call the DLNA apparatus shortcut list from the lower-layer service component 521.

The shortcut menu bar module 530 is configured to form a DLNA apparatus list shortcut menu bar according to the DLNA apparatus shortcut list called by the upper-layer application 522; and the display module 540 is configured to display the DLNA apparatus list shortcut menu bar.

The display module 540 is further configured to receive an instruction of dragging the shared file onto an icon of a target DLNA apparatus in the DLNA apparatus shortcut list that is displayed in the form of the DLNA apparatus list shortcut menu bar, and display an animation of the instruction. The DLNA apparatus shortcut list comprises at least one icon of at least one DLNA apparatus.

The DLNA module 520 is configured to match a type of the target DLNA apparatus with a type of the shared file.

The shortcut operation module 550 is configured to enable the target DLNA apparatus to process the shared file if the DLNA module 520 match the type of the target DLNA apparatus with the type of the shortcut file successfully.

It should be appreciated that, working principles and specific operations of the handheld apparatus 500 of this embodiment are the same as those of the embodiment shown in FIG. 1, and thus will not be further described herein.

It should be understood that, in the embodiments provided in the present disclosure, the apparatuses and methods disclosed may also be embodied in other forms. The embodiments of the handheld apparatus described above are only provided fur illustration; and the division of modules described only represents a division of logical functions, and there may be other division manners in practical implementations. For example, a number of modules may be combined to form a single module or may be integrated into another system, or some features may be omitted or may not be performed. Furthermore, mutual coupling or communication connections between the modules may be achieved via a plurality of interfaces, or in an electrical way, a mechanical way or some other way.

As integral components of an intelligent terminal, the aforesaid function modules may be or may not be physical units, may be co-located at a same site or be distributed in a plurality of network units, and may be implemented either in the form of hardware or in the form of software function units. The objective of the present disclosure can be achieved by optionally using a part of or all of the modules depending on to the actual need.

According to the above descriptions, the present disclosure can search for DLNA apparatuses that are in a connected status in the DLNA network via the handheld apparatus, display the corresponding DLNA apparatus information in the DLNA apparatus shortcut list, and then drag a file to be shared onto an icon of a corresponding DLNA apparatus in the DLNA apparatus shortcut list, thus achieving the playing or sending of the shared file. The present disclosure can achieve quick sharing of files, and feature simple operations and high accuracy.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

What is claimed is:

1. A file sharing method, comprising:
after a handheld apparatus entering a DLNA network, adding the handheld apparatus into a DLNA sharing apparatus group in a wireless network by a lower-layer service component of a DLNA module, and acquiring information of available DLNA apparatuses that are in a connected status in the DLNA network to form a DLNA apparatus shortcut list;
entering a file library of the handheld apparatus, dragging a shared file towards a status bar of the handheld apparatus, calling the DLNA apparatus shortcut list from the lower-layer service component by an upper-layer application, displaying the DLNA apparatus shortcut list in the form of a DLNA apparatus list shortcut menu bar, and then dragging the shared file onto an icon of a target DLNA apparatus in the DLNA apparatus shortcut list that is displayed in the form of the DLNA apparatus list shortcut menu bar, wherein the DLNA apparatus shortcut list comprises at least one icon of at least one DLNA apparatus;
matching a type of the target DLNA apparatus with a type of the shared file by the DLNA module; and
enabling the target DLNA apparatus to process the shared file by the handheld apparatus if matching successfully.

2. The file sharing method of claim 1, wherein the step of the hand e d apparatus entering the DLNA network comprises:
activating a WIFI function by the handheld apparatus to search for and enter the wireless network; and
activating the upper-layer application by the DLNA module to enter the DLNA network.

3. The file sharing method of claim 1, wherein the step of enabling the target DLNA apparatus to process the shared file by the handheld apparatus, comprises:
receiving an instruction of pulling down a status bar by the handheld apparatus, and displaying a handheld apparatus shortcut menu bar according to the instruction;
calling the DLNA apparatus shortcut list from the lower-layer service component by the upper-layer application via clicking an icon of the upper-layer application in the handheld apparatus shortcut menu bar, and displaying the DLNA apparatus shortcut list in the form of the DLNA apparatus list shortcut menu bar;
entering an operation interface of the target DLNA apparatus by clicking the icon of the target DLNA apparatus in the DLNA apparatus shortcut menu bar; and
processing the shared file via the operation interface of the target DLNA apparatus displayed by the handheld apparatus.

4. The file sharing method of claim 1, wherein the step of enabling the target DLNA apparatus to process the shared file by the handheld apparatus comprises:
calling the upper-layer application by the handheld apparatus and entering a main interface of the upper-layer application, wherein the DLNA apparatus shortcut list is displayed in the main interface;
entering an operation interface of the target DLNA apparatus by clicking the icon of the target DLNA apparatus in the DLNA apparatus shortcut list; and
processing the shared file via the operation interface of the target DLNA apparatus displayed by the handheld apparatus.

5. A file sharing method, comprising:
after a handheld apparatus entering a DLNA network, acquiring information of available DLNA apparatuses that are in a connected status in the DLNA network by a DLNA module, to form a DLNA apparatus shortcut list;
dragging a shared file onto an icon of a target DLNA apparatus in the DLNA apparatus shortcut list, wherein the DLNA apparatus shortcut list comprises at least one icon of at least one DLNA apparatus;
matching a type of the target DLNA apparatus with a type of the shared file by the DLNA module; and
enabling the target DLNA apparatus to process the shared file by the handheld apparatus if matching successfully.

6. The file sharing method of claim 5, wherein the step of the handheld apparatus entering the DLNA network comprises:
activating a WIFI function by the handheld apparatus to search for and enter a wireless network; and
activating an upper-layer application by the DLNA module o enter the DLNA network.

7. The file sharing method of claim 5, wherein the step of acquiring information of available DLNA apparatuses that are in a connected status in the DLNA network by the DLNA module to form the DLNA apparatus shortcut list comprises:
adding the handheld apparatus into a DLNA sharing apparatus group in a wireless network by a lower-layer service component of the DLNA module, and acquiring the information of the available DLNA apparatuses that are in a connected status in the DLNA network to form the DLNA apparatus shortcut list.

8. The file sharing method of claim 5, wherein the step of dragging the shared file onto the icon of the target DLNA apparatus in the DLNA apparatus shortcut list comprises:
entering a file library of the handheld apparatus, and dragging the shared file wards a status bar of the handheld apparatus;
calling the DLNA apparatus shortcut list from a lower-layer service component by an upper-layer application and displaying the DLNA apparatus shortcut list in the form of a DLNA apparatus list shortcut menu bar; and
dragging the shared file onto the icon of the target DLNA apparatus in the DLNA apparatus shortcut menu bar.

9. The file sharing method of claim 5, wherein the step of enabling the target DLNA apparatus to process the shared file by the handheld apparatus, comprises:
receiving an instruction of pulling down a status bar by the handheld apparatus, and displaying a handheld apparatus shortcut menu bar according to the instruction;
calling the DLNA apparatus shortcut list from a lower-layer service component by an upper-layer application via clicking an icon of the upper-layer application in the handheld apparatus shortcut menu bar, and displaying the DLNA apparatus shortcut list in the form of a DLNA apparatus list shortcut menu bar;
entering an operation interface of the target DLNA apparatus by clicking the icon of the target DLNA apparatus in the DLNA apparatus shortcut menu bar; and
processing the shared file via the operation interface of the target DLNA apparatus displayed by the handheld apparatus.

10. The file sharing method of claim 5, wherein the step of enabling the target DLNA apparatus to process the shared file by the handheld apparatus, comprises:
calling an upper-layer application by the handheld apparatus and entering a main interface of the upper-layer application, wherein the DLNA apparatus shortcut list is displayed in the main interface;
entering an operation interface of the target DLNA apparatus by clicking the icon of the target DLNA apparatus in the DLNA apparatus shortcut list; and
processing the shared file via the operation in face of the target DLNA apparatus displayed by the handheld apparatus.

11. A handheld apparatus for sharing a file, the handheld apparatus sharing the file via a wireless network, and the handheld apparatus comprising:
a DLNA module, being configured to acquire information of available DLNA apparatuses that are in a connected status in the DLNA network to form a DLNA apparatus shortcut list after the handheld apparatus enters a DLNA network;
a display module, being configured to display the DLNA apparatus shortcut list and receive an instruction of dragging the shared file onto an icon of a target DLNA apparatus in the DLNA apparatus shortcut list, and display a corresponding animation according to the instruction, wherein the DLNA apparatus shortcut list comprises at least one icon of at least one DLNA apparatus;
the DLNA module is further configured to match a type of the target DLNA apparatus with a type of the shared file; and
a shortcut operation module, being configured to enable the target DLNA apparatus to process the shared file after matching successfully.

12. The handheld apparatus of claim 11, further comprising a WIFI module, wherein the WIFI module is configured to activate a WIFI function to search for and enter a wireless network, and the DLNA module activates an upper-layer application to enter the DLNA network.

13. The handheld apparatus of claim 12, wherein the DLNA module further comprises a lower-layer service component, wherein the lower-layer service component is configured to add the handheld apparatus into a DLNA sharing apparatus group in the wireless network, and acquire the DLNA apparatus shortcut list from the wireless network, and the upper-layer application is configured to call the DLNA apparatus shortcut list from the lower-layer service component.

14. The handheld apparatus of claim 13, further comprising a shortcut menu bar module, which is configured to form a DLNA apparatus list shortcut menu bar according to the DLNA apparatus shortcut list called by the upper-layer application of the DLNA module.
